(19) United States
(12) Patent Application Publication
(10) Pub. No.: US 2018/0313949 A1
(43) Pub. Date: Nov. 1, 2018

(54) INSPECTION DEVICE FOR DETECTING OBJECTS INSIDE SHOES

(71) Applicants: SHENZHEN CCT THZ TECHNOLOGY CO., LTD., Shenzhen (CN); CHINA COMMUNICATION TECHNOLOGY CO., LTD., Shenzhen (CN)

(72) Inventors: Chunchao QI, Shenzhen (CN); Zhihui Feng, Shenzhen (CN); Guangsheng Wu, Shenzhen (CN); Shukai Zhao, Shenzhen (CN); Qing Ding, Shenzhen (CN)

(21) Appl. No.: 16/029,679

(22) Filed: Jul. 9, 2018

Related U.S. Application Data
(63) Continuation of application No. PCT/CN2016/091940, filed on Jul. 27, 2016.

(30) Foreign Application Priority Data
Apr. 27, 2016 (CN) 201610269182.1

(51) Int. Cl. G01S 13/88; G01S 13/89

(52) U.S. Cl. CPC G01S 13/887; G01S 13/89

(57) ABSTRACT

The present disclosure relates to an inspection device for detecting objects inside shoes, including: a transmitting antenna array configured to radiate a millimeter-wave signal to an under-test object, and a millimeter-wave transmitting branch configured to provide the millimeter-wave signal for the transmitting antenna array; a receiving antenna array configured to receive an echo signal of the under-test object, and a millimeter-wave receiving branch configured to receive the echo signal received by the receiving antenna array; and a slide guide, the transmitting antenna array and the receiving antenna array being slidably connected to the slide guide. By adopting the solution of the present disclosure, convenient and quick inspection for detecting objects inside shoes of a under-test person can be achieved without requiring the under-test person to take off the shoes thereof.

### FIELD OF THE INVENTION

The present disclosure generally relates to the technical field of security inspection, and more particularly, relates to an inspection device for detecting objects inside shoes.

### BACKGROUND OF THE INVENTION

Currently, security inspection is necessary in important places concerning life security of a nation and people, eg., at train stations, airports, ports, customs or the like. In order to avoid inspection, criminals often hide tools for criminal purposes, explosive and drugs inside bodies or shoes.

Millimeter-waves are electromagnetic waves of which the wavelength ranges between microwaves and optical waves, the frequency ranges from 30 Ghz to 300 Ghz. Millimeter-waves can penetrate clothes and some insulators with the minimum reflection and attenuation, so human body imaging security inspection using the millimeter-wave technology is considered as a method for replacing or used in combination with other security inspection manners.

For millimeter-wave imaging systems currently available, security staff often require a under-test person to take off his/her shoes for inspection, which is embarrassing and increases the inspection time and is quite inapplicable especially at the peak time for passengers.

### SUMMARY OF THE INVENTION

An objective of the present disclosure is to provide an inspection device for detecting objects inside shoes, which can achieve convenient and quick inspection for detecting objects inside shoes of an under-test person without requiring the under-test person to take off the shoes thereof.

The objective of the present disclosure is achieved by the following technical solutions:

the present disclosure provides an inspection device for detecting objects inside shoes include:
a transmitting antenna array configured to radiate a millimeter-wave signal to an under-test object, and a millimeter-wave transmitting branch configured to provide the millimeter-wave signal for the transmitting antenna array;
a receiving antenna array configured to receive an echo signal of the under-test object, and a millimeter-wave receiving branch configured to receive the echo signal received by the receiving antenna array; and
a slide guide, the receiving antenna array being slidably connected to the slide guide.

The above solution of the present disclosure adopts the millimeter-wave imaging technology, which is harmless to human bodies, convenient to operate, has a low operational cost, and more importantly, saves security inspection time and avoids the embarrassment caused by taking off the shoes during the security inspection. The above solution adopts the transmitting antenna array to radiate a millimeter-wave signal and receive an echo signal of the under-test object via the receiving antenna array., and the transmitting antenna array and the receiving antenna array slidably connect to the slide guide, or the transmission device drives the transmitting antenna array and the receiving antenna array to translate. The inspection device for detecting objects inside shoes of the present disclosure may be integrated with an on-site millimeter-wave imaging security inspection tester to achieve all-around efficient scanning and clear imaging, thereby forming two-dimensional image information of shoes of the under-test person according to the echo signal to determine whether threatening objects are hidden inside the shoes.

In one embodiment, the transmitting antenna array comprises a plurality of transmitting antenna units, the receiving antenna array comprises a plurality of receiving antenna units, and the transmitting antenna units and the receiving antenna units are arranged alternately, thereby further improving the inspection effect.

In one embodiment, the transmitting antenna array and the receiving antenna array both extend in a first direction, the slide guide or the transmission device extends in a second direction, and the first direction and the second direction form an angle of 90 degrees, thereby improving the scanning efficiency.

In one embodiment, the millimeter-wave transmitting branch comprises a first voltage-controlled oscillator, a first frequency multiplying link and a first broadband filter that are connected in sequence, thereby generating a millimeter-wave signal satisfying the requirements.

In one embodiment, the millimeter-wave receiving branch comprises a second voltage-controlled oscillator, a second frequency multiplying link, a MMIC frequency mixer, a low-noise amplifier and a second broadband filter that are connected in sequence.

In one embodiment, the aforesaid inspection device for detecting objects inside shoes further comprising a wave-transparent baffle having a first side and a second side opposite to the first side, wherein the transmitting antenna array and the receiving antenna array are located on the first side of the wave-transparent baffle, and the under-test object is located on the second side of the wave-transparent baffle. The wave-transparent baffle, on the one hand achieves the purpose of protecting the transmitting antenna array and the receiving antenna array, and on the other hand achieves the transmission of the millimeter-wave signal as much as possible.

In one embodiment, the millimeter-wave signal provided by the millimeter-wave transmitting branch is in a frequency band from 10 GHz to 40 GHz, and the millimeter-wave transmitting branch has a output power greater than 15 dBm, thereby improving the imaging resolution and sufficiently transmitting through the shoe soles.

In one embodiment, the aforesaid millimeter-wave imaging device for inspecting detecting objects inside shoes further comprising a driving device; and the driving device configured to drive the transmitting antenna array and the receiving antenna array to slide along the slide guide, or configured to drive the transmission device to move the transmitting antenna array and the receiving antenna array.

In one embodiment, the aforesaid inspection device for detecting objects inside shoes further comprising a signal collecting and processing device, and the signal collecting and processing device includes:

a signal collecting device configured to perform simulation differential digitized processing on a processing result of the millimeter-wave receiving branch;

a pre-processing device configured to perform pre-processing computation on a processing result of the signal collecting device; and

an imaging processing device configured to perform image reconstruction, feature extraction, mode recognition, image enhancement on a processing result of the pre-processing device to obtain image information of the under-test object.

In one embodiment, the aforesaid inspection device for detecting objects inside shoes further comprising a display device, and the display device configured to display the image information of the under-test object.

### BRIEF DESCRIPTION OF THE DRAWINGS

FIG. 1 is a first schematic view illustrating a constituent structure of an inspection apparatus for detecting objects inside shoes according to one embodiment of the present disclosure;

FIG. 2 is a schematic view illustrating an application scenario of the inspection device for detecting objects inside shoes in FIG. 1:

FIG. 3 is a schematic view illustrating the arrangement of a transmitting antenna array and a receiving antenna array of FIG. 1 in one embodiment;

FIG. 4 is a schematic view illustrating a constituent structure of a millimeter-wave transmitting branch of FIG. 1 in one embodiment:

FIG. 5 is a schematic view illustrating a constituent structure of a millimeter-wave receiving branch of FIG. 1 in one embodiment;

FIG. 6 is a second schematic view illustrating a constituent structure of the inspection device for detecting objects inside shoes according to one embodiment of the present disclosure;

FIG. 7 is a third schematic view illustrating a constituent structure of the inspection device for detecting objects inside shoes according to one embodiment of the present disclosure;

FIG. 8 is a fourth schematic view illustrating a constituent structure of the inspection device for detecting objects inside shoes according to one embodiment of the present disclosure;

FIG. 9 is a fifth schematic view illustrating a constituent structure of the inspection device for detecting objects inside shoes according to one embodiment of the present disclosure:

FIG. 10 is a first schematic view illustrating a constituent structure of an inspection device for detecting objects inside shoes according to another embodiment of the present disclosure; and

FIG. 11 is a second schematic view illustrating a constituent structure of the inspection device for detecting objects inside shoes according to another embodiment of the present disclosure.

### DETAILED DESCRIPTION OF THE INVENTION

To make objectives, technical solutions and advantages of the present disclosure clearer and easier to be understood, the present disclosure will be further described in detail hereinafter with reference to attached drawings and embodiments. It shall be appreciated that, specific embodiments described herein are only used for explaining the present disclosure and not intended to limit the scope of the present disclosure.

In order to make it convenient to understand the solution of the present disclosure, the principle of an active millimeter-wave imaging security inspection system is first briefly described hereinafter. For the active millimeter-wave imaging security inspection system, firstly a signal is transmitted to a human body and a back scattering signal is received, then imaging is performed using a three-dimensional reconstruction algorithm, and finally two-dimensional projection is performed in each direction and the two-dimensional images are inspected and recognized to accomplish the inspection for dangerous items. In compared to the passive imaging system, the active imaging system has many advantages such as a fast inspection speed and without being influenced by the environment (the temperature, sunlight, and ambient radiating sources) or the like.

### Embodiment 1

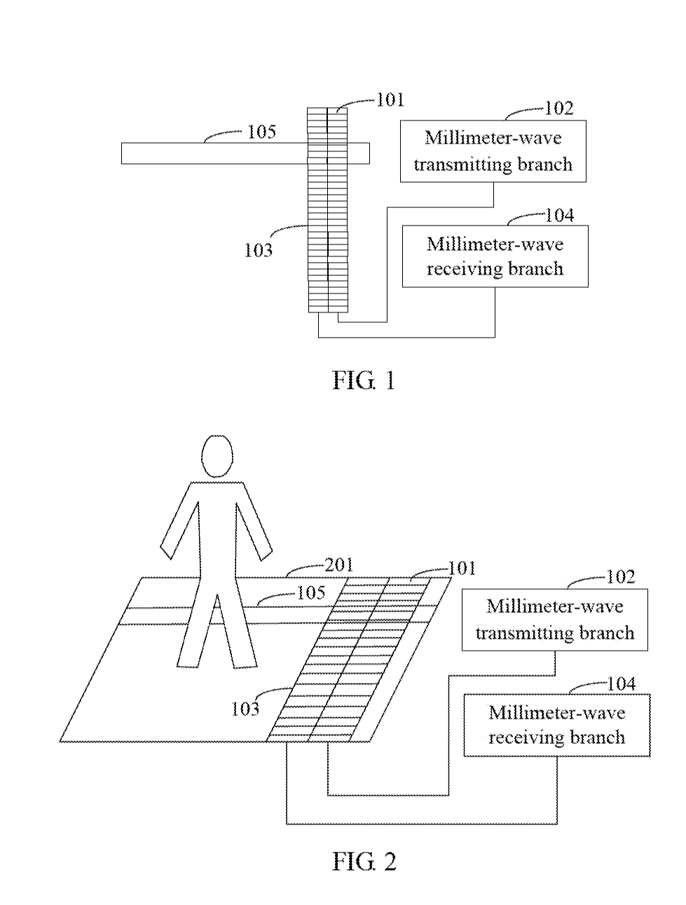

One embodiment of the present disclosure provides an inspection device for detecting objects inside shoes. FIG. 1 is a schematic view illustrating a constituent structure of an inspection device for detecting objects inside shoes according to one embodiment of the present disclosure. As shown in FIG. 1, the inspection device for detecting objects inside shoes of this embodiment includes:

a transmitting antenna array 101 configured to radiate a millimeter-wave signal to an under-test object, and a millimeter-wave transmitting branch 102 configured to provide the millimeter-wave signal for the transmitting antenna array 101;

a receiving antenna array 103 configured to receive an echo signal of the under-test object, and a millimeter-wave receiving branch 104 configured to receive the echo signal received by the receiving antenna array 103; and

a slide guide 105, the transmitting antenna array 101 and the receiving antenna array 103 being slidably connected to the slide guide 105.

As it known to those skilled in the art, the transmitting antenna array 101 and the receiving antenna array 103 being slidably connected to the slide guide 105 means that the transmitting antenna array 101 and the receiving antenna array 103 may slide along corresponding sliding trajectory of the slide guide 105, and the slide guide 105 is generally fixed.

During the specific operation, the inspection device for detecting objects inside shoes of the embodiment may be used to integrate with a millimeter-wave imaging security inspection tester to achieve all-around efficient scanning of the under-test person without requiring the under-test person to take off the shoes. Specifically as shown in FIG. 2, the under-test person stands on an under-test area 201, and when the transmitting antenna array 101 and the receiving antenna array 103 move along the slide guide 105, the millimeter-wave transmitting branch 102 radiates a millimeter-wave signal to the under-test person via the transmitting antenna array 101, the millimeter-wave receiving branch 104 receives an echo signal of the under-test person via the receiving antenna array 103, and the echo signal is inputted into the millimeter-wave imaging security inspection tester to obtain an image of the person-under-test. The solution of the embodiment adopts the millimeter-wave imaging technology, which is harmless to human bodies, convenient to operate, achieves clear imaging, has a low operational cost, and more importantly, saves security inspection time and avoids the embarrassment caused by taking off the shoes during the security inspection.

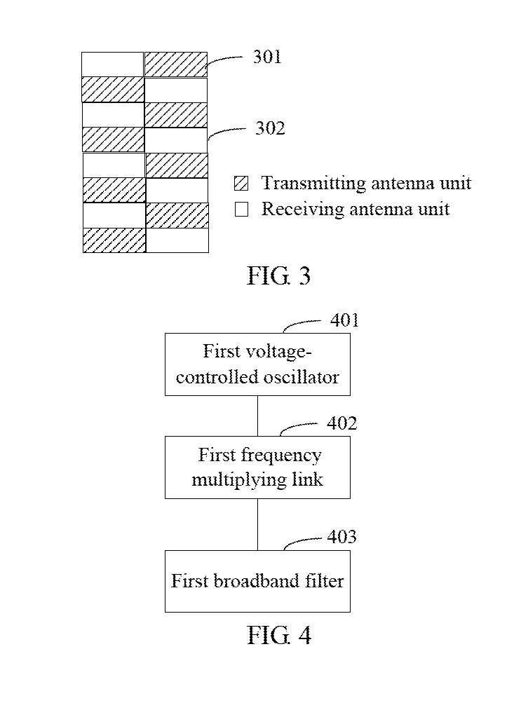

As shown in FIG. 3, the transmitting antenna array 101 includes multiple transmitting antenna units 301, and the receiving antenna array 103 includes multiple receiving antenna units 302, and the transmitting antenna units 301 and the receiving antenna units 302 are arranged alternately. For example, as shown in FIG. 3, the inspection device includes two rows of the antenna units, the first antenna unit in the first row is the transmitting antenna unit 301, the second antenna unit in the first row is the receiving antenna unit 302, the third antenna unit in the first row is the transmitting antenna unit 301, the fourth antenna unit in the first row is the receiving antenna unit 302, and so on. The first antenna unit in the second row is the receiving antenna unit 302, the second antenna unit in the second row is the transmitting antenna unit 301, the third antenna unit in the second row is the receiving antenna unit 302, the fourth antenna unit in the second row is the transmitting antenna unit 301, and so on. However, it shall be stated that, the number of rows of the antenna units are not limited to two rows, and the alternate arrangement is not limited thereto. For example, the inspection device may also include four rows of antenna units, wherein the first and the third rows are the transmitting antenna units 301, the second and the fourth rows are the receiving antenna units 302, or the transmitting antenna units 301 and the receiving antenna units 302 are staggered. The scanning effect can be improved by adopting the solution of the embodiment.

In one embodiment, the transmitting antenna array 101 and the receiving antenna array 103 both extend in a first direction, the slide guide extends in a second direction, and the first direction and the second direction form an angle of 90 degrees. By adopting the solution of the embodiment, the transmitting antenna array 101 and the receiving antenna array 103 can accomplish the scanning of the under-test object within the shortest sliding distance, thereby improving the inspection speed.

In one embodiment, as shown in FIG. 4, the millimeter-wave transmitting branch 102 includes a first voltage-controlled oscillator 401, a first frequency multiplying link 402 and a first broadband filter 403 that are connected in sequence. In the embodiment, the first voltage-controlled oscillator 401 and the first frequency multiplying link 402 form a millimeter-wave local oscillator that can generate and output a millimeter-wave signal. Specifically, the first voltage-controlled oscillator 401 provides the first frequency multiplying link 402 with a baseband signal, the baseband signal becomes a broadband millimeter-wave signal after the clock multiplier for several times, and the broadband millimeter-wave signal is outputted after being filtered by the first broadband filter 403. However, it shall be stated that, the constituent structure of the millimeter-wave transmitting branch 102 is not limited to the constituent structure provided in the embodiment.

Considering that what scanned are detecting objects inside shoes and the shoe soles are relatively thick, in one embodiment, the output power of the millimeter-wave transmitting branch 102 is greater than 15 dBm, so that the millimeter-wave signal is sufficient to transmit through the shoe soles. Meanwhile, the frequency band of the −millimeter-wave signal transmitted by the millimeter-wave transmitting branch 102 is from 10 Ghz to 40 Ghz, the broad frequency band can provides a better imaging resolution. Moreover, the perfect harmonic suppression of the millimeter-wave transmitting branch 102 is greater than 25 dBc. The dBm refers to decibel with respect to a milliwatt, the Ghz refers to gigahertz, and the dBc is the unit of harmonic suppression (decibels).

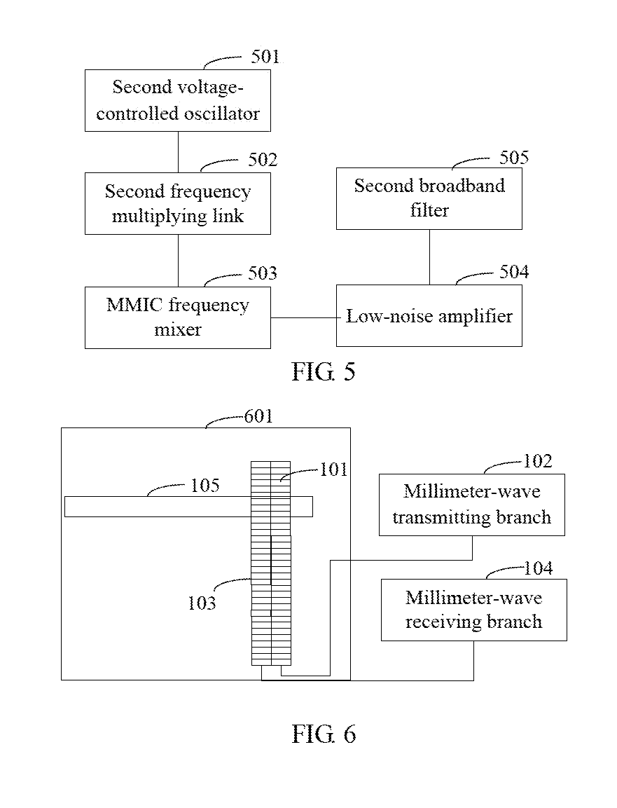

In one embodiment, as shown in FIG. 5, the millimeter-wave receiving branch 104 includes a second voltage-controlled oscillator 501, a second frequency multiplying link 502, a MMIC frequency mixer 503, a low-noise amplifier 504 and a second broadband filter 505 that are connected in sequence. The received echo signal is processed by the millimeter-wave receiving branch 104 in the embodiment to generate an intermediate frequency signal for use in the subsequent imaging processing. However, it shall be stated that, the constituent structure of the millimeter-wave receiving branch 104 is not limited to the constituent structure provided in the embodiment.

In one embodiment, as shown in FIG. 6, the inspection device for detecting objects inside shoes of the present disclosure may further include a wave-transparent baffle 601 having a first side and a second side opposite to the first side. The transmitting antenna array 101 and the receiving antenna array 103 are located on the first side of the wave-transparent baffle 601, and the under-test object is located on the second side of the wave-transparent baffle 601. The wave-transparent baffle 601, on the one hand, achieves the purpose of protecting the transmitting antenna array 101 and the receiving antenna array 103 as well as other relevant components from artificial destruction, and on the other hand, reduces the loss of the millimeter-wave signal as much as possible.

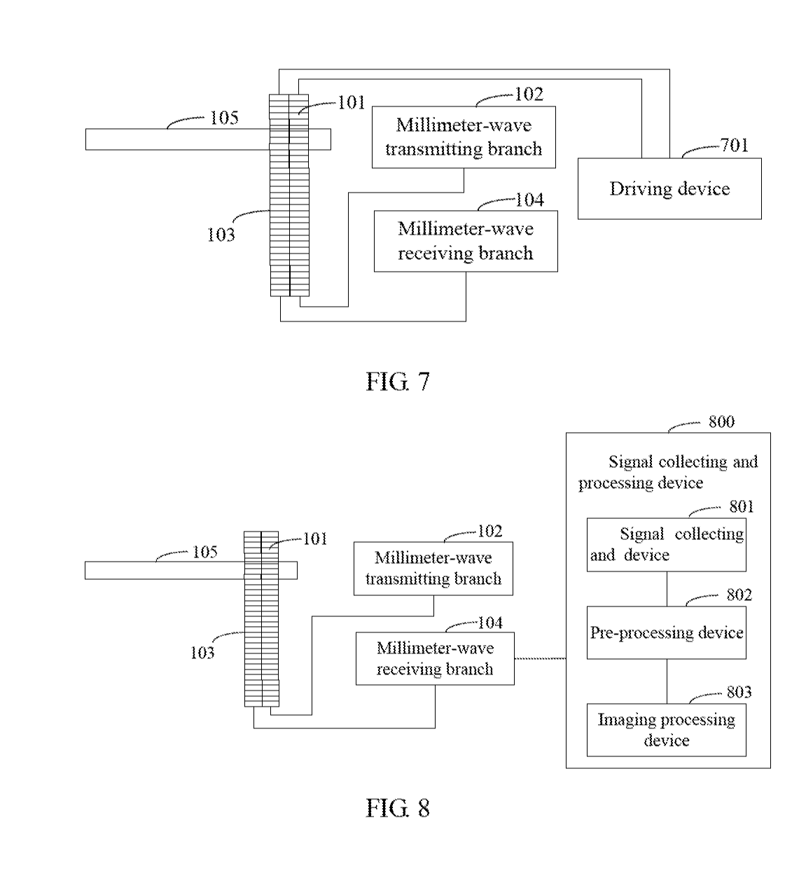

In one embodiment, as shown in FIG. 7, the inspection device for detecting objects inside shoes of the present disclosure may further include a driving device 701, and the driving device 701 configured to drive the transmitting antenna array 101 and the receiving antenna array 103 to slide along the slide guide 105. Specifically, the driving device 701 may include a motor. The under-test person stands on the under-test area, and when the motor drives the transmitting antenna array 101 and the receiving antenna array 103 to slide along the slide guide 105, the millimeter-wave signal radiated by the transmitting antenna array 101 penetrates through the shoes of the under-test person and reaches the bottom of the feet of the under-test person, and then is reflected back to the receiving antenna array 103 from the bottom of the feet of the under-test person, thereby achieving transverse scanning and forming two-dimensional image information to determine hidden threatening information.

In one embodiment, based on any of the aforesaid embodiments, as shown in FIG. 8, the inspection device for detecting objects inside shoes of the present disclosure may further include a signal collecting and processing device 800, and the signal collecting and processing device 800 includes:

a signal collecting device 801 configured to perform simulation differential digitized processing on a processing result of the millimeter-wave receiving branch 104;

a pre-processing device 802 configured to perform pre-processing computation on a processing result of the signal collecting device 801;

The pre-processing computation may include filtering operation, normalization processing or the like depending on needs; and

an imaging processing device 803 configured to perform image reconstruction, feature extraction, mode recognition, image enhancement on a processing result of the pre-processing device 802 to obtain image information of the under-test object.

The image reconstruction, feature extraction, mode recognition, and image enhancement all can be achieved in the currently available manner, and thus will not be further described herein.

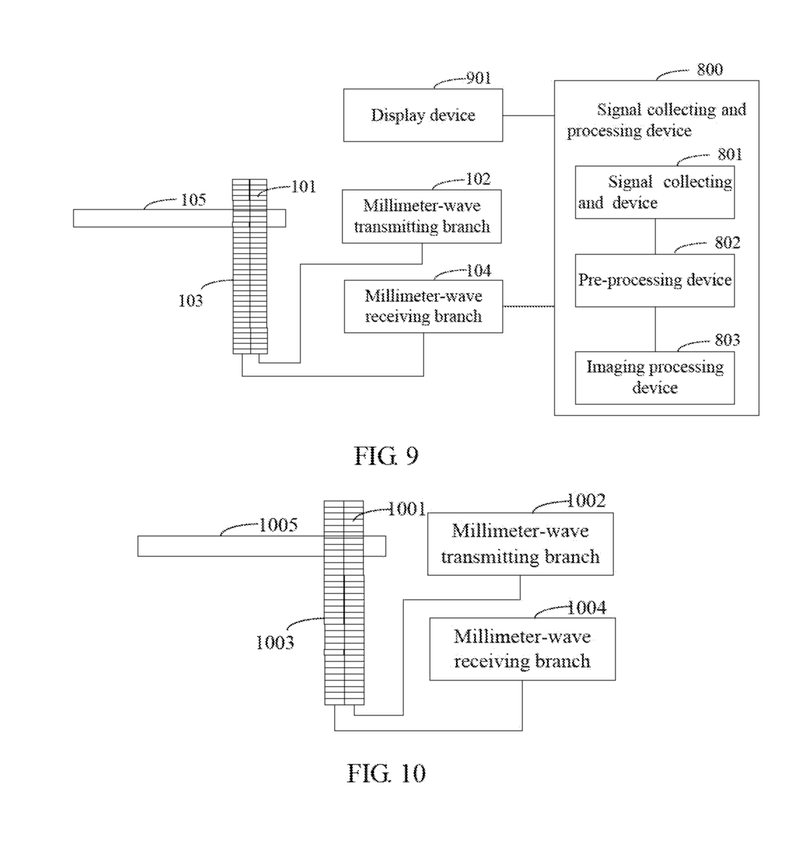

In one embodiment, based on the last embodiment, as shown in FIG. 9, the inspection device for detecting objects inside shoes of the present disclosure may further include a display device 901, and the display device 901 configured to display the image information of the under-test object.

During the specific operation, when the inspection device for detecting objects inside shoes of the embodiment is in use and the transmitting antenna array 101 and the receiving antenna array 103 slide along the slide guide 105, the millimeter-wave transmitting branch 102 radiates the millimeter-wave signal to the object-under-test through the transmitting antenna array 101, and the millimeter-wave receiving branch 104 receives the echo signal of the under-test object through the receiving antenna array 103. The signal collecting and processing device 800 performs simulation differential digitized processing, pre-processing and imaging processing on the processing result (e.g., the intermediate frequency signal as described above) of the millimeter-wave receiving branch 104 in sequence, and the imaging processing described herein includes image reconstruction, feature extraction, mode recognition, and image enhancement. In this way, the image information of the under-test object is obtained, and the image information may be displayed by the display device 901.

### Embodiment 2

Based on the aforesaid embodiment, another embodiment of the present disclosure further provides an inspection device for detecting objects inside shoes. FIG. 10 is a schematic view illustrating a constituent structure of an inspection device for detecting objects inside shoes according to another embodiment of the present disclosure. As shown in FIG. 10, the inspection device for detecting objects inside shoes of the embodiment includes:

a transmitting antenna array 1001 configured to radiate a millimeter-wave signal to an under-test object, and a millimeter-wave transmitting branch 1002 configured to provide the millimeter-wave signal for the transmitting antenna array 1001;

a receiving antenna array 1003 configured to receive an echo signal of the under-test object, and a millimeter-wave receiving branch 1004 configured to receive the echo signal received by the receiving antenna array 1003; and

a transmission device 1005 configured to drive the transmitting antenna array 1001 and the receiving antenna array 1003 to translate.

During the specific operation, the inspection device for detecting objects inside shoes of the embodiment may be used to integrate with a millimeter-wave imaging security inspection tester to achieve all-around efficient scanning of the under-test object without requiring the under-test object to take off the shoes. Specifically, when the transmission device 1005 drives the transmitting antenna array 1001 and the receiving antenna array 1003 to translate, the millimeter-wave transmitting branch 1002 radiates a millimeter-wave signal to the under-test object via the transmitting antenna array 1001, the millimeter-wave receiving branch 1004 receives an echo signal of the under-test object through the receiving antenna array 1003, and the echo signal is inputted into the millimeter-wave imaging security inspection tester to obtain an image of the under-test object. The solution of the embodiment adopts the millimeter-wave imaging technology, which is harmless to human bodies, convenient to operate, achieves clear imaging, has a low operational cost, and more importantly, saves security inspection time and avoids the embarrassment caused by taking off the shoes during the security inspection.

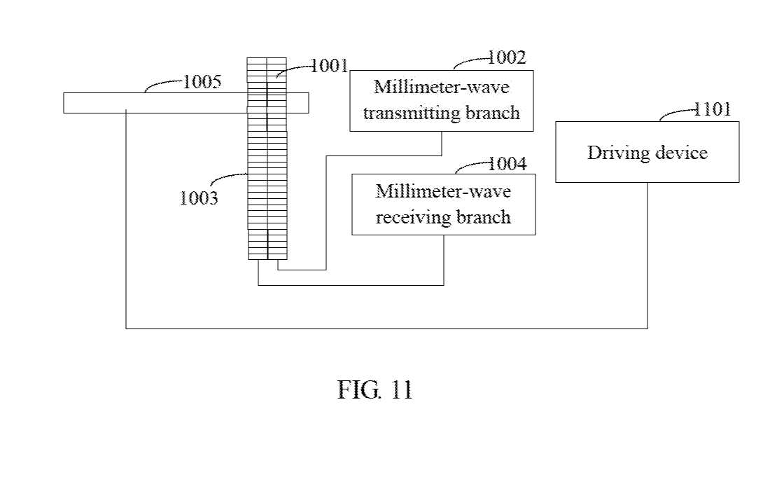

In one embodiment, as shown in FIG. 11, the inspection device for detecting objects inside shoes may further comprise a driving device 1101, and the driving device 1101 configured to drive the transmission device 1005 to move the transmitting antenna array 1001 and the receiving antenna array 1003.

For the inspection device for detecting objects inside shoes that is provided in the another embodiment of the present disclosure, it shall be noted that: the description of the inspection device for detecting objects inside shoes of the above embodiment is similar to the description of the inspection device for detecting objects inside shoes of the one embodiment, other further improvements in the above embodiment are also applicable to the inspection device for detecting objects inside shoes of this embodiment and achieve the beneficial effects of the inspection device for detecting objects inside shoes of the above embodiment, and this will not be further described herein for simplification of the description. Therefore, please refer to the description of the inspection device for detecting objects inside shoes provided in the above embodiment for technical details undisclosed in the description of the inspection device for detecting objects inside shoes provided in the embodiment of the present disclosure.

The technical features of the above-mentioned embodiments may be combined arbitrarily. For the sake of the brevity of the description, possible combinations of the technical features in the above embodiments are not all described. However, as long as there is no contradiction in the combination of these technical features, all should be considered as within the scope of this specification.

The above-mentioned embodiments merely represent several examples of the present disclosure, and the description thereof is more specific and detailed, but it should not be considered as limitations to the scope of the present disclosure. It should be noted that, for those skilled in the art, various variations and improvements may be made without departing from the concept of the present disclosure and are all within the protection scope of the present disclosure. Therefore, the protection scope of the present disclosure shall be subject to the appended claims.

What is claimed is:

1. An inspection device for detecting objects inside shoes, comprising:
a transmitting antenna array configured to radiate a millimeter-wave signal to an under-test object, and a millimeter-wave transmitting branch configured to provide the millimeter-wave signal for the transmitting antenna array;
a receiving antenna array configured to receive an echo signal of the under-test object, and a millimeter-wave receiving branch configured to receive the echo signal received by the receiving antenna array; and
a slide guide, the transmitting antenna array and the receiving antenna array being slidably connected to the slide guide.

2. The inspection device of claim 1, wherein the transmitting antenna array comprises a plurality of transmitting antenna units, the receiving antenna array comprises a plurality of receiving antenna units, and the transmitting antenna units and the receiving antenna units are arranged alternately.

3. The inspection device of claim 1, wherein the transmitting antenna array and the receiving antenna array both extend in a first direction, the slide guide or the transmission device extends in a second direction, and the first direction and the second direction form an angle of 90 degrees.

4. The inspection device of claim 1, wherein the millimeter-wave transmitting branch comprises a first voltage-controlled oscillator, a first frequency multiplying link and a first broadband filter that are connected in sequence.

5. The inspection device of claim 1, wherein the millimeter-wave receiving branch comprises a second voltage-controlled oscillator, a second frequency multiplying link, a MMIC frequency mixer, a low-noise amplifier and a second broadband filter that are connected in sequence.

6. The inspection device of claim 1, further comprising a wave-transparent baffle having a first side and a second side opposite to the first side, wherein the transmitting antenna array and the receiving antenna array are located on the first side of the wave-transparent baffle, and the under-test object is located on the second side of the wave-transparent baffle.

7. The inspection device of claim 1, wherein the millimeter-wave signal provided by the millimeter-wave transmitting branch is in a frequency band from 10 GHz to 40 GHz, and the millimeter-wave transmitting branch has a output power greater than 15 dBm.

8. The inspection device of claim 1, further comprising a driving device;
the driving device configured to drive the transmitting antenna array and the receiving antenna array to slide along the slide guide, or configured to drive the transmission device to move the transmitting antenna array and the receiving antenna array.

9. The inspection device of claim 1, further comprising a signal collecting and processing device, the signal collecting and processing device comprising:
a signal collecting device configured to perform simulation differential digitized processing on a processing result of the millimeter-wave receiving branch;
a pre-processing device configured to perform pre-processing computation on a processing result of the signal collecting device; and
an imaging processing device configured to perform image reconstruction, feature extraction, mode recognition, image enhancement on a processing result of the pre-processing device to obtain image information of the under-test object.

10. The inspection device of claim 9, further comprising a display device, the display device configured to display the image information of the under-test object.

11. An inspection device for detecting objects inside shoes, comprising:
a transmitting antenna array configured to radiate a millimeter-wave signal to an under-test object, and a millimeter-wave transmitting branch configured to provide the millimeter-wave signal for the transmitting antenna array;
a receiving antenna array configured to receive an echo signal of the under-test object, and a millimeter-wave receiving branch configured to receive the echo signal received by the receiving antenna array, and
a transmission device, the transmission device being configured to drive the transmitting antenna array and the receiving antenna array to translate.

12. The inspection device of claim 1, wherein the transmitting antenna array comprises a plurality of transmitting antenna units, the receiving antenna array comprises a plurality of receiving antenna units, and the transmitting antenna units and the receiving antenna units are arranged alternately.

13. The inspection device of claim 1, wherein the transmitting antenna array and the receiving antenna array both extend in a first direction, the slide guide or the transmission device extends in a second direction, and the first direction and the second direction form an angle of 90 degrees.

14. The inspection device of claim 1, wherein the millimeter-wave transmitting branch comprises a first voltage-controlled oscillator, a first frequency multiplying link and a first broadband filter that are connected in sequence.

15. The inspection device of claim 11, wherein the millimeter-wave receiving branch comprises a second voltage-controlled oscillator, a second frequency multiplying link, a MMIC frequency mixer, a low-noise amplifier and a second broadband filter that are connected in sequence.

16. The inspection device of claim 11, further comprising a wave-transparent baffle having a first side and a second side opposite to the first side, wherein the transmitting antenna array and the receiving antenna array are located on the first side of the wave-transparent baffle, and the under-test object is located on the second side of the wave-transparent baffle.

17. The inspection device of claim 1, wherein the millimeter-wave signal provided by the millimeter-wave transmitting branch is in a frequency band from 10 GHz to 40 GHz, and the millimeter-wave transmitting branch has a output power greater than 15 dBm.

18. The inspection device of claim 11, further comprising a driving device;
the driving device configured to drive the transmitting antenna array and the receiving antenna array to slide along the slide guide, or configured to drive the transmission device to move the transmitting antenna array and the receiving antenna array.

19. The inspection device of claim 11, further comprising a signal collecting and processing device, the signal collecting and processing device comprising:
a signal collecting device configured to perform simulation differential digitized processing on a processing result of the millimeter-wave receiving branch;
a pre-processing device configured to perform pre-processing computation on a processing result of the signal collecting device; and
an imaging processing device configured to perform image reconstruction, feature extraction, mode recognition, image enhancement on a processing result of the pre-processing device to obtain image information of the under-test object.

20. The inspection device of claim 19, further comprising a display device, the display device configured to display the image information of the under-test object.
